(19) United States
(12) Patent Application Publication
(10) Pub. No.: US 2025/0381569 A1
(43) Pub. Date: Dec. 18, 2025

(54) CUTTING TOOL AND CUTTING SYSTEM FOR A COMMINUTING ROTOR

(71) Applicant: PRINOTH GmbH, Herdwangen (DE)

(72) Inventors: Daniel BRAUN, Radolfzell (DE); Markus HOSTI, Stockach (DE); Andreas MÖHRLE, Herdwangen (DE)

(21) Appl. No.: 19/216,482

(22) Filed: May 22, 2025

(30) Foreign Application Priority Data
Jun. 13, 2024 (DE) 10 2024 116 586.3

(51) Int. Cl. B02C 18/18

(52) U.S. Cl. CPC B02C 18/18; B02C 2201/066

(57) ABSTRACT

A cutting tool for a comminuting rotor, in particular for a comminution of at least one of wood and soil, includes at least one cutting edge and at least one fastening region that is preferably at least partly realized as a fastening hollow and includes in a longitudinal extent two subregions which are oriented at an angle to each other, wherein the subregions include an angle which is greater than 90 degrees.

### CROSS-REFERENCE TO RELATED APPLICATION

As a U.S. follow-up application, this patent application is based on and claims priority to German patent application DE 10 2024 116 586.3, filed on Jun. 13, 2024, the contents of which are incorporated herein by reference.

### PRIOR ART

The invention concerns a cutting tool and a cutting system.

The document EP 2 852 464 A1 discloses a cutting tool for a comminuting rotor, in particular for a comminution of wood and/or soil, with at least one cutting edge, and with at least one fastening region comprising in a longitudinal extent two subregions which are oriented at an angle to each other.

The objective of the invention is in particular to provide a generic cutting tool having improved properties with regard to strength, easy assembly and operationally reliable assembly. The objective is achieved according to the invention.

### ADVANTAGES OF THE INVENTION

The invention is based on a cutting tool for a comminuting rotor, in particular for a comminution of wood and/or soil, with at least one cutting edge and with at least one fastening region that is preferably at least partly realized as a fastening hollow and comprises in a longitudinal extent two subregions which are oriented at an angle to each other.

It is proposed that the subregions include an angle A which is greater than 90 degrees. By a “cutting tool” is in particular a unit to be understood which is configured for comminuting, in particular cutting and/or chopping and/or breaking up, material, in particular wood and/or soil, in particular also rock. In particular, the cutting tool is configured to be fastened to a base element of a cutting system, which is connected to the comminuting rotor. Preferably the cutting tool can be fastened to the base element in an exchangeable manner. Preferably the cutting tool can be mounted to a base element via a connection that is preferably not detachable without destruction. Preferably the cutting tool can be connected to the base element by means of a screw connection. By a “cutting tool” is preferably a unit to be understood which has at least one cutting edge. In an operating state the cutting tool absorbs forces that act on the cutting edge and/or discharges said forces. Preferably the cutting tool may be realized by a base body comprising a cutting-edge receptacle in which a cutting edge, for example a hardened cutting edge, in particular a cutting edge made of a hard metal, is connected. Preferably a cutting edge is connected to a cutting-edge receptacle of the base body of the cutting tool via a soldered connection. In principle it would also be conceivable for the cutting edge to be fixedly connected to the cutting-edge receptacle of the base body via a welded connection. In principle it is also conceivable for the cutting edge to be connected to the base body by means of another connection method. In principle it is also conceivable for the cutting edge to be realized integrally with a base body of the cutting tool. In the case of an integral realization of the cutting edge with the base body of the cutting tool, the entire cutting tool is formed integrally from a single component, preferably as a forged part. By a “comminuting rotor” is preferably a rotation body to be understood to the lateral surface of which preferably a plurality of base elements are connected, wherein in each case a cutting tool can be connected via said base elements. A “comminuting rotor” is preferably to mean a rotation body that is configured to be equipped with at least one cutting tool for carrying out a comminuting process. In an operating state the comminuting rotor rotates around its longitudinal axis, as a result of which the cutting tool is brought into contact with the material that is to be comminuted. A “longitudinal axis” of the comminuting rotor is in particular to mean a rotational-symmetry axis of a geometrical cylinder with the smallest volume just still enclosing the comminuting rotor. The comminuting rotor in particular comprises a base body which is preferably realized in a rotationally symmetrical manner and to which at least one base element is fastened, preferably in a rotationally fixed manner. Particularly advantageously the base body is realized at least partially as a round tube. Herein the base element may be fastened to the base body in any manner deemed expedient by a person skilled in the art, in particular by a screw connection and preferably by an integral implementation. Preferably the base element is welded with the base body. A “fastening region” is preferably to mean a region via which the cutting tool can be fastened to a base element that is realized correspondingly. The fastening region forms a contact surface with which the cutting tool adjoins a correspondingly realized fastening region of the base element. Preferably the fastening region is realized at least partially, i.e. in at least one region, as a fastening hollow.

Preferably the fastening region is realized in at least one of the two subregions at least section-wise, preferably completely, as a fastening hollow. Particularly preferably the fastening region is realized in both subregions at least section-wise, preferably completely, as a fastening hollow. In principle it would also be conceivable that the fastening region is realized in one of the subregions, for example the first subregion, as a fastening hollow and in the other subregion, i.e. for example the second subregion, as a planar surface. By a “fastening hollow” is preferably a hollow to be understood which is introduced at least into a side of the cutting tool and is configured for positioning and fixing the cutting tool to a base element that is realized correspondingly. A “longitudinal extent” is preferably to mean an extent of the cutting tool from an upper end to a lower end. “At an angle to each other” is preferably to mean that longitudinal extension axes of the two subregions are arranged at an angle A with respect to each other and are not oriented parallel to each other. The angles between two subregions are preferably measured between two main extension planes of the respective subregions. If the subregions each have a planar bottom, the angle between the subregions may preferably be measured between the respective bottoms, which are for example realized as grooves.

The cutting tool, and preferably also the base element, is/are preferably realized as a forged part/forged parts. Forged parts produced in a forging process have tolerances which must be taken into account in particular with respect to angle specifications. The angles specified above and below are always to be understood as designed angles which the cutting tool and/or the base element were designed with. Due to the respective tolerances, an angle may deviate by up to 2 degrees in a correspondingly produced component. “Configured” is in particular to mean specifically designed and/or equipped. By an object being configured for a specific function is in particular to be understood that the object fulfils and/or carries out said specific function in at least one application state and/or operating state. An implementation according to the invention advantageously allows providing a cutting tool that is especially robust and can be mounted to a base element in a particularly simple manner. Particularly preferentially, forces acting on the cutting tool during operation can be discharged into the base element in a particularly effective manner. The implementation according to the invention in particular allows providing a cutting tool having a long service life. In particular, simple assembly and disassembly are also achievable by the cutting tool according to the invention.

It is further proposed that the subregions include an angle A of 95 degrees to 120 degrees, preferably of 100 degrees to 115 degrees, with each other. Especially advantageously, the two subregions of the fastening region include an angle of 110 degrees with each other. This allows realizing the fastening region in a particularly advantageous manner in order to achieve especially advantageous support of forces occurring during operation.

Moreover it is proposed that the cutting tool has a fastening hole longitudinal axis, with the first subregion including an angle B with the fastening hole longitudinal axis which differs from an angle C included by the fastening hole longitudinal axis with the second subregion. A “fastening hole longitudinal axis” is preferably to mean a middle axis of a fastening hole introduced in the cutting tool, in particular in the base body of the cutting tool. By a “fastening hole” is preferably a hole to be understood via which the cutting tool can be fixed to a base element in a positionally fixed manner. The fastening hole preferably has a round cross section. Preferably the fastening hole is realized as a bore. Preferably the fastening hole is configured such that a fastening member, which is configured for fixing the cutting tool, is at least partially guided through and/or fastened in the fastening hole. Preferably the fastening hole has an internal thread. Preferably the fastening hole, which has an internal thread, is configured such that for connecting the cutting tool to a base element a fastening member, for example a screw, is screwed into the fastening hole. Preferably the fastening hole introduced in the cutting tool is realized as a blind hole. However, in principle it would also be conceivable that the fastening hole is realized as a through hole. This allows realizing the fastening region in a particularly advantageous manner and providing especially advantageous support of operating forces. Advantageously the cutting tool can thus be realized in a particularly simple and cost-effective manner, and quick and secure assembly/disassembly of the cutting tool is enabled. Advantageously, secure fastening of the cutting tool to a base element is also achievable.

It is also proposed that the cutting tool has a fastening hole longitudinal axis, wherein a first subregion of the fastening region includes an angle B with the fastening hole longitudinal axis which is between 65 degrees and 75 degrees. Preferably the angle B included by the first subregion with the fastening hole longitudinal axis is between 68 degrees and 72 degrees, and in a particularly advantageous exemplary embodiment it is 70 degrees. This allows realizing the fastening region in a particularly advantageous manner and providing especially advantageous support of operating forces.

It is further proposed that the cutting tool has a fastening hole longitudinal axis, wherein the second subregion of the fastening region includes an angle C with the fastening hole longitudinal axis which is between 35 degrees and 45 degrees. Preferably the angle C included by the second subregion with the fastening hole longitudinal axis is between 38 degrees and 42 degrees, and in a particularly advantageous exemplary embodiment it is 40 degrees. This allows realizing the fastening region in a particularly advantageous manner and providing especially advantageous support of operating forces.

Furthermore, it is proposed that the first subregion is realized as a main support region having a greater extent than the second subregion. A “main support region” is preferably to mean a region via which a large portion of the operating forces acting on the cutting tool during operation can be supported, and can in particular be discharged to a base element. For this purpose, the first subregion of the fastening region, which is realized as a main support region, is preferably oriented substantially orthogonally to a cutting-edge movement direction. By the first subregion having a greater extent is to be understood that the first subregion has a greater extent in the longitudinal extent than the second subregion. The first subregion is longer in its longitudinal direction than the second subregion. The second subregion is shorter in its longitudinal direction than the first subregion. This allows providing an especially advantageous support surface for operating forces.

Beyond this, it is proposed that the first subregion is realized as at least one subregion of a rear side of the cutting tool. By a “rear side of the cutting tool” is preferably a side to be understood which faces away from the cutting edge of the cutting tool. This allows realizing the cutting tool in an especially advantageous manner. Moreover, this enables advantageous force transmission to a base element.

It is further proposed that the second subregion is realized as at least one subregion of an underside of the cutting tool. In this way the cutting tool can be realized in an especially advantageous manner. Advantageously, in this way especially simple and accurate positioning of the cutting tool on a base element is achievable.

Beyond this, it is proposed that the cutting tool has a cutting-edge movement direction, wherein a first subregion of the fastening region includes an angle D with the cutting-edge movement direction which is between 79 degrees and 89 degrees. Preferably the angle D included by the first subregion with the cutting-edge movement direction is between 82 degrees and 86 degrees, and in a particularly advantageous exemplary embodiment it is 84 degrees. A “cutting-edge movement direction” is preferably to mean a direction in which a cutting edge of the cutting tool moves during operation. Preferably the cutting-edge movement direction is herein realized as a straight movement component in which the cutting edge would move at a defined point in time due to the rotation of the comminuting rotor. This allows realizing the fastening region in a particularly advantageous manner and providing especially advantageous support of operating forces.

It is also proposed that the cutting tool has a cutting-edge movement direction, wherein the second subregion of the fastening region includes an angle E with the cutting-edge movement direction that is between 9 degrees and 19 degrees. Preferably the angle E included by the second subregion with the cutting-edge movement direction is between 24 degrees and 28 degrees, and in a particularly advantageous exemplary embodiment it is 14 degrees. This allows realizing the fastening region in a particularly advantageous manner and providing especially advantageous support of operating forces.

Furthermore, it is proposed that the fastening region is realized at least partially as a wedge-shaped groove having side walls which are arranged at an angle F, G to each other that is in a range from 130 degrees to 172 degrees. A “wedge-shaped groove” is preferably to mean a groove which is formed by two side walls facing each other. The side walls are preferably realized as planar surfaces. However, in principle it is also conceivable that the side walls have a convex or concave shape at least in subregions. For example, it would be conceivable that in subregions the side surfaces are realized in a spherical shape. The side walls which realize a wedge-shaped groove preferably include an obtuse angle with each other. Preferably, the fastening region realized as a wedge-shaped groove has a groove bottom realized as a web by which the two obliquely-extending side walls are arranged spaced apart from each other at a lower end of the fastening region. However, in principle it would also be conceivable that the fastening region realized as a wedge-shaped groove does not have a groove bottom realized as a web, with the side walls meeting directly at the groove bottom. By the fastening region realized as a fastening hollow being “realized at least partially as a wedge-shaped groove” is to be understood that it is possible for the fastening region having only in at least one region side walls which form a wedge-shaped groove. Preferably the fastening region is realized as a wedge-shaped groove over its entire longitudinal extent. However, in principle it would also be conceivable that only in a subregion the fastening region realized as a fastening hollow has oblique side walls and is formed as a wedge-shaped groove, but has a different shape in a remaining region. It would be conceivable that the fastening region is realized as a wedge-shaped groove in less than 50% of its longitudinal extent. In principle it would also be conceivable that the fastening region is realized as a wedge-shaped groove in several regions which are spaced apart from one another. The fastening region is preferably realized at least partially as a wedge-shaped groove in the first subregion and in the second subregion. In the first subregion, the fastening region has side walls which form the wedge-shaped groove including an angle F with each other which is between 130 degrees and 140 degrees, especially preferably between 133 degrees and 137 degrees, and in a particularly advantageous embodiment 135 degrees. In the second subregion, the fastening region has side walls which form the wedge-shaped groove including an angle G with each other which is between 162 degrees and 172 degrees, especially preferably between 165 degrees and 169 degrees, and in a particularly advantageous embodiment degrees 167.5 degrees. Preferably, the fastening region is realized as a wedge-shaped groove in the first subregion and in the second subregion. However, in principle it would also be conceivable that the fastening region is realized as a wedge-shaped groove only in one of the subregions, in particular in the first subregion, and in the second subregion forms a flat contact surface or a contact elevation. This allows realizing the fastening region in a particularly advantageous manner in order to have, in a fastened state, an especially advantageous hold in a transverse direction.

It is moreover proposed that the fastening region is realized at least partially as a wedge-shaped groove in each of its two subregions, with side walls of the wedge-shaped grooves having different angles F, G to each other in the two subregions. Preferably, the angles F, G, with which the side walls of the wedge-shaped grooves are respectively arranged in the two subregions, differ from each other, preferably by at least 10 degrees, preferably by at least 20 degrees and especially preferentially by more than 30 degrees. As a result, especially advantageous support of the operating forces can take place via the different subregions.

It is further proposed that the cutting tool has a fastening hole which extends from a rear side into the cutting tool and is configured for fastening a fastening member. A “rear side” is to mean a side of the cutting tool, in particular of the base body of the cutting tool, which faces away from the cutting edge. This allows realizing the cutting tool in a particularly advantageous manner for a simple and secure connection to a base element.

It is further proposed that the fastening hole is realized as a blind hole having an internal thread. This allows realizing the fastening hole in a particularly advantageous manner for a simple connection of the cutting tool by means of a fastening member that is realized as a screw.

Beyond this it is proposed that the cutting tool comprises at least one cutting edge, which is arranged at an upper end on a front side of the cutting tool. Preferably the cutting edge may be realized integrally with a base body of the cutting tool or as a separate cutting edge, in particular a hard-metal cutting edge, which is connected rigidly in a cutting-edge receptacle of the base body by material bond, preferably via a soldered connection. This allows realizing the cutting tool in a particularly advantageous manner.

Moreover, a cutting system with a cutting tool is proposed, wherein the cutting system comprises a base element which is configured for a rigid connection to the comminuting rotor and which has on a front side a contact region configured for the cutting tool to adjoin with its fastening region at least partially in a form-fitting manner. A “cutting system” preferably means a system of at least one base element and a cutting tool that can be fastened thereto. A “base element” is preferably to mean an element that is fixedly and rigidly connected to a comminuting rotor and is configured for a connection to a cutting tool that is not detachable without destruction. Preferably a cutting tool can be fastened to the base element in a non-destructively detachable manner via a screw connection by means of a screw. The base element is preferably configured to be rigidly connected to the comminuting rotor by material bond, via a welded connection. By a “contact region” is preferably a region to be understood which is at least partially adjoined by a cutting tool with its fastening region that is preferably realized as a fastening hollow, and via which forces, in particular operating forces, are discharged from the cutting tool into the base element. The contact region is realized correspondingly to the fastening region. Preferably the cutting tool adjoins the contact region over a large portion of its fastening region, or over the entire longitudinal extent of the fastening region. In principle it is also conceivable that the cutting tool adjoins the contact region only in subregions that make up less than 50% of the longitudinal extent of the fastening region. Preferably the cutting tool adjoins the contact region with the side walls of its fastening region, which form the wedge-shaped groove. The side walls of the fastening region of the cutting tool preferably lie planarly on correspondingly realized surfaces of the contact region. Preferably the contact region has side surfaces which form a wedge-shaped elevation and are thus realized correspondingly to the fastening region that is formed as a wedge-shaped groove. Preferably it is also conceivable that in a mounted state only subregions of the side walls of the fastening region, which form a wedge-shaped groove, adjoin the side surfaces of the contact region. This advantageously allows providing a system by way of which cutting tools can be attached to a comminuting rotor in a particularly simple and secure manner via a base element.

It is furthermore proposed that the contact region comprises a first subregion, which is realized correspondingly to the first subregion of the cutting tool, and comprises a second subregion, which is realized correspondingly to the second subregion of the cutting tool. That the subregions are realized correspondingly is to mean that regions, in particular the respective side walls of the fastening region of the cutting tool and the side surfaces of the contact region of the base element, are in each case realized such that in a correctly mounted state they lie substantially planarly upon one another. Preferably the side walls of the fastening region of the cutting tool and the side surfaces of the contact region of the base element in each case have an identical inclination with respect to a middle longitudinal plane. Preferably it may be provided that in at least one subregion the side walls of the fastening region of the cutting tool and the side surfaces of the contact region of the base element have inclinations differing by 0.5 degrees to 1.5 degrees, such that in a mounted state the side walls of the fastening region and the side surfaces of the contact region are tensioned against one another in order to achieve a particularly firm and stable connection between the cutting tool and the base element. In this way the cutting tool can be connected to the base element in a particularly simple and secure manner via the contact region.

Moreover it is proposed that the contact region comprises a second subregion, which at least partially forms a wedge-shaped elevation, with the side surfaces of the wedge-shaped elevations including an angle I which is minimally greater, preferably by 0.1 degrees to 3.5 degrees greater, than the angle B of the second subregion of the cutting tool. Preferably the angle I included by the side surfaces of the wedge-shaped elevation in the second subregion is greater by 0.5 degrees to 1.5 degrees, and in a particularly preferred exemplary embodiment it is greater by 1 degree. In this way the cutting tool can be particularly advantageously tensioned in a connection to the base element in order to thus ensure particularly secure and firm mounting of the cutting tool to the base element.

It is also proposed that the second subregion of the contact region has an extent which is smaller than a thickness of the cutting tool at its lower end. As a result, the cutting tool lies with its underside, which forms the second subregion of the fastening region, only partially on the base element, i. e. on the second subregion of the contact region. This allows realizing the base element in a particularly advantageous manner.

In addition, it is proposed that in a state when the cutting tool is mounted to the base element, the cutting tool projects with its underside beyond the second subregion of the contact region of the base element. Preferably, the region of the underside of the cutting tool which projects beyond the contact region of the base element is no longer part of the second subregion of the fastening recess of the cutting tool. As a result, the base element can, in a particularly advantageous manner, be covered and thus protected in its front region by the cutting tool during operation. Advantageously, this enables achieving especially favorable wear protection for the cutting tool.

It is further proposed that the base element does not engage around the cutting tool. This allows achieving especially simple mounting and demounting of the cutting tool on/from the base element.

The cutting tool according to the invention shall not be limited to the above-described application and implementation. In particular, in order to fulfil a functionality that is described here, the cutting tool according to the invention may have a number of individual elements, components and units that differs from a number given here.

### DRAWINGS

Further advantages will become apparent from the following description of the drawings. Two exemplary embodiments of the invention are illustrated in the drawings. The drawings, the description and the claims contain numerous features in combination. Someone skilled in the art will purposefully also consider the features individually and will find further expedient combinations.

In the drawings:

FIG. 1 shows a schematic illustration of a comminuting rotor according to the invention, with a cutting system according to the invention comprising a plurality of base elements and cutting tools fastened to the base elements,

FIG. 2 shows a schematic view of a cutting system comprising a base element and the cutting tool fastened thereto, in particular screwed thereto,

FIG. 3 shows a sectional view through a middle plane of the cutting tool and of the base element,

FIG. 4 shows a schematic side view of the cutting tool according to the invention,

FIG. 5 shows a schematic rear view of the cutting tool according to the invention, with a fastening hollow comprising two subregions, wherein an angle G of the second subregion is drawn,

FIG. 6 shows a schematic view from below of the cutting tool according to the invention, with the fastening hollow comprising the two subregions, wherein an angle F of the first subregion is drawn,

FIG. 7 shows a schematic side view of the base element according to the invention of the cutting system,

FIG. 8 shows a schematic plan view of the base element with its contact region for a connection of a cutting tool,

FIG. 9 shows a schematic view from below of the base element with its receiving region for a connection of a cutting tool, and

FIG. 10 shows a schematic illustration of a cutting tool in a second exemplary embodiment, comprising a cutting edge that is realized integrally with a base body.

### DESCRIPTION OF THE EXEMPLARY EMBODIMENTS

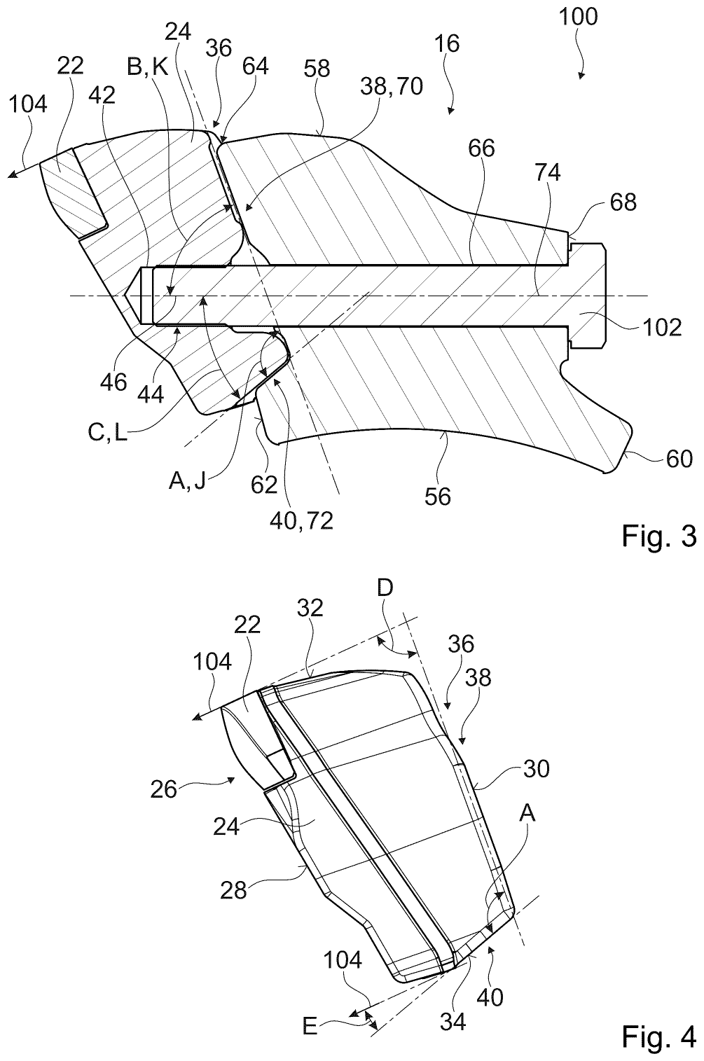

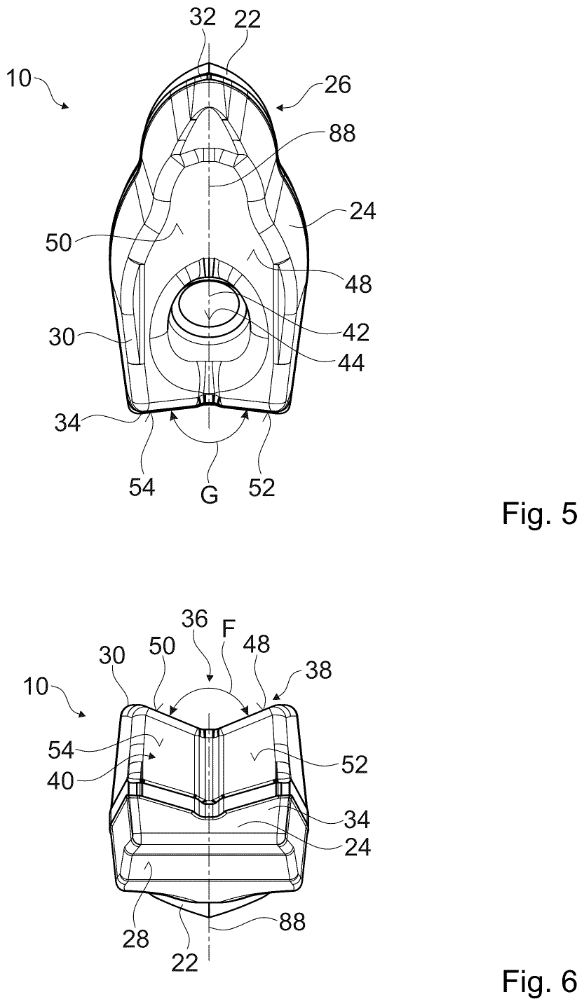

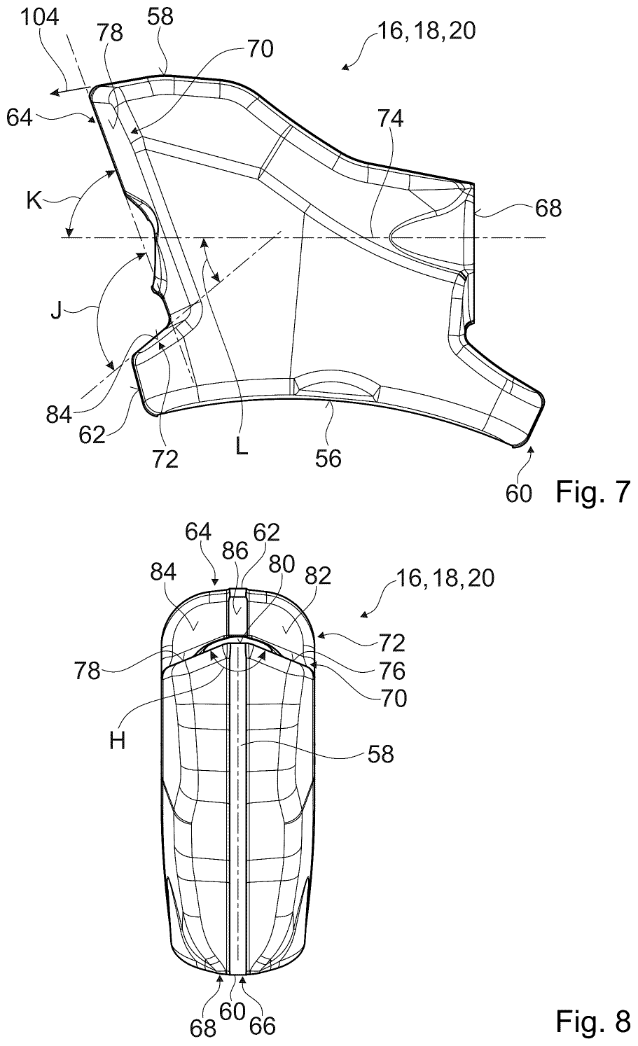

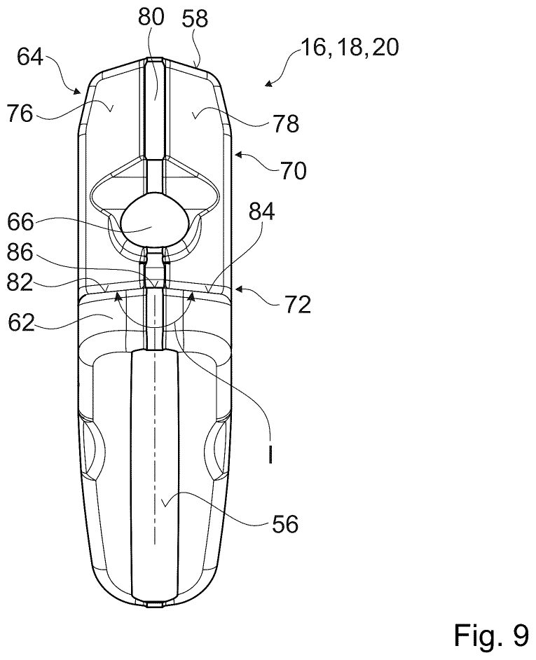

FIGS. 1 to 9 show a first exemplary embodiment of a cutting tool 10 according to the invention of a cutting system 100 according to the invention. In FIG. 1 a comminuting rotor 12 according to the invention is shown, which comprises a cutting system 100 according to the invention with a plurality of cutting tools 10 according to the invention. Such comminuting rotors 12 are in particular used in attachment tools for commercial vehicles, in particular for mulching and/or shredding. The comminuting rotor 12 is configured for a comminution of wood and/or soil. The comminuting rotor 12 has a base body 14. The base body 14 is realized in the form of a roller. The base body 14 is realized in a tube shape. The base body 14 is preferably made of steel. The cutting system 100 comprises a plurality of base elements 16, 18, 20. The base elements 16, 18, 20 are fixedly fastened to the comminuting rotor 12. The base elements 16, 18, 20 are preferably connected to the base body 14 of the comminuting rotor 12 by material bond. The base elements 16, 18, 20 are preferably welded with the comminuting rotor 12. The base elements 16, 18, 20 are preferably rigidly connected to a casing of the comminuting rotor 12 via a welded connection.

To each base element 16, 18, 20 of the cutting system 100 a cutting tool 10 is connected. The cutting tools 10 are in each case fixedly connected to the comminuting rotor 12 via the base elements 16, 18, 20. In the following, only one cutting tool 10 and the corresponding base element 16 will be described in detail. The further cutting tools 10 are preferably realized identically. However, in principle it would also be conceivable that at least some of the further cutting tools 10 are realized partly in a different manner.

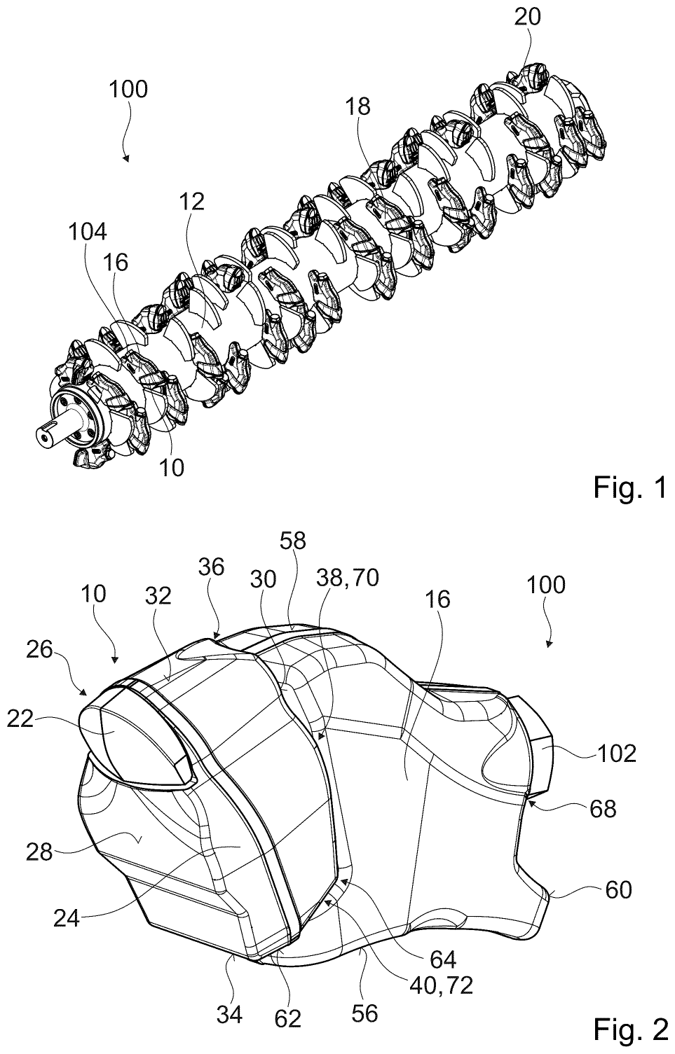

In FIG. 2 an isometric view is shown of the base element 16 with the cutting tool 10 fastened thereto. The cutting tool 10 comprises a cutting edge 22. The cutting edge 22 is fixedly attached at the cutting tool 10. Preferably the cutting edge 22 is connected to the cutting tool 10 by material bond. In this exemplary embodiment the cutting edge 22 is realized as a cutting edge made of a hardened metal. The cutting edge 22 is realized as a hard-metal cutting edge. The cutting tool 10 comprises a base body 24. The base body 24 is made of a metal. The base body 24 is preferably made from a forged part. The base body 24 forms a cutting-edge receptacle 26. The cutting edge 22 is fixedly connected in the cutting-edge receptacle 26 of the base body 24. The cutting edge 22 is fastened to the cutting-edge receptacle 26 in a loss-proof manner. The cutting edge 22 is connected in the cutting-edge receptacle 26 of the base body 24 by material bond, preferably via a soldered connection. In principle it would also be conceivable that the cutting edge 22 is fastened to the cutting-edge receptacle 26 in a different loss-proof manner: by a force-fitting connection, a form-fitting connection and/or by material bond. The base body 24 and the cutting edge 22 together form the cutting tool 10. In principle an integral implementation of the cutting edge 22 and the base body 24 of the cutting tool 10 would also be conceivable. The base body 24 and the cutting edge 22 would be formed together from a single material, in particular from a blank. The base body 24 and the cutting edge 22 would be realized together as a forged part. In principle it would also be conceivable that the base body 24, or the base body 24 together with the cutting edge 22, is realized as a milled component. Preferably it is conceivable that a forged part forming the base body 24 and/or the cutting edge 22 is reworked by milling in a machining step.

The base body 24 of the cutting tool 10 has a front side 28. In a mounted state, the front side 28 faces away from the base element 16. The base body 24 of the cutting tool 10 has a rear side 30. In a mounted state, the rear side 30 of the cutting tool 10 faces towards the base element 16. The base body 24 of the cutting tool 10 has an upper side 32. In a mounted state, the upper side 32 of the cutting tool 10 faces away from an underside of the base element 16, in particular from the comminuting rotor 12. The base body 24 of the cutting tool 10 has an underside 34. In a mounted state, the underside 34 of the cutting tool 10 faces towards an underside of the base element 16, in particular towards the comminuting rotor 12. The cutting edge 22 of the cutting tool 10 is attached to the front side 28. The cutting edge 22 is attached to the front side 28 of the cutting tool 10 in an upper region that adjoins the upper side 32. The cutting edge 22 may project beyond the upper side 32 of the base body 24. The cutting-edge receptacle 26 is introduced in the base body 24 in the upper region of the front side 28, which adjoins the upper side 32.

The cutting tool 10 comprises a fastening region 36. The cutting tool 10 can be fastened to one of the base elements 16, 18, 20 via the fastening region 36. The fastening region 36 is realized as a fastening hollow. In the following, only a connection of the cutting tool 10 to the one base element 16 will be described, wherein a connection of the cutting tool 10 to the further base elements 18, 20 is realized in an equivalent manner. The cutting tool 10 can be coupled to the base element 16 via the fastening region 36. In a mounted state, the cutting tool 10 is supported on the base element 16 via the fastening region 36. The cutting tool 10 is coupled in a form-fitting manner via the fastening region 36 at least in two directions, preferably in three or four directions. As a result of the form-fitting support via the fastening region 36, the cutting tool 10 can be supported on the base element 16 in two directions, preferably in three or four directions.

The fastening region 36 is arranged on the rear side 30 of the cutting tool 10. The fastening region 36 is arranged in the underside 34 of the cutting tool 10. The fastening region 36 extends partly in the rear side 30 and partly in the underside 34 of the cutting tool 10. The fastening region 36 preferably extends from an upper end of the rear side 30 as far as a lower end of the rear side 30. Preferably, the fastening region 36 is realized continuously in a height axis, i.e. from a lower end as far as an upper end of the rear side 30. However, in principle it would also be conceivable that the fastening region 36 is not realized continuously, for example does not reach as far as the upper side 32 or the underside 34.

The fastening region 36 extends at least over a portion of the underside 34. Preferably, the fastening region 36 extends from a rear end of the underside 34 towards a front side 28 of the cutting tool 10.

The fastening region 36 preferably extends centrally on the rear side 30 of the cutting tool 10. The fastening region 36 preferably likewise extends centrally on the underside 34. The fastening region 36 is preferably introduced in the cutting tool 10 centrally in a transverse direction. The fastening region 36 is thus in particular arranged centrally between lateral walls of the cutting tool 10. The fastening region 36 preferably has a middle plane 88. The middle plane 88 of the fastening region 36 extends centrally in the cutting tool 10 in the transverse direction. Preferably the fastening region 36 extends in a transverse direction substantially over the entire width of the rear side 30. Preferably the fastening region 36 likewise extends in a transverse direction substantially over the entire width of the underside 34. In principle it would also be conceivable that on the rear side 30 and/or on the underside 34 the fastening region 36 does not extend over an entire width in the transverse direction. Herein it would be conceivable that lateral regions of the rear side 30 and/or of the underside 34 would respectively be at least partially free of the fastening region 36.

The fastening region 36 is realized in an elongate fashion. The fastening region 36 of the cutting tool 10 has a longitudinal extent. The longitudinal extent of the fastening region 36 extends in the middle plane 88 of the fastening region 36 from an upper end of the fastening region 36 in the rear side 30 as far as a lower end of the fastening region 36 in the underside 34. The fastening region 36 comprises two subregions 38, 40 in its longitudinal extent. The two subregions 38, 40 are oriented at an angle to each other. The fastening region 36 is hence realized with an angle in its longitudinal extent. The fastening region 36 has a kink in its longitudinal extent. The two subregions 38, 40 of the fastening region 36 are preferably arranged in different sides of the cutting tool 10. The first subregion 38 is arranged on the rear side 30. The first subregion 38 is realized as at least one subregion of the rear side 30 of the cutting tool 10. The portion of the fastening region 36 that is arranged on the rear side 30 of the cutting tool 10 forms the first subregion 38 of the fastening region 36. The second subregion 40 is arranged on the underside 34. The second subregion 40 is realized as at least one subregion of the underside 34 of the cutting tool 10. The portion of the fastening region 36 that is arranged on the underside 34 of the cutting tool 10 forms the second subregion 40 of the fastening region 36. The first subregion 38 of the fastening region 36 is realized as a main support region. The first subregion 38 has a greater extent than the second subregion 40 of the fastening region 36. Preferably a large portion of the forces that occur during operation are supported via the first subregion 38 on the corresponding base element 16 and thus on the comminuting rotor 12.

The subregions 38, 40, which are oriented at an angle to each other, include an angle A with each other which is greater than 90 degrees. Preferentially the two subregions 38, 40 of the fastening region 36 include an angle A from 95 degrees to 120 degrees, preferably from 100 degrees to 115 degrees. Preferably the two subregions 38, 40 of the fastening region 36 include an angle A of 110 degrees.

The cutting tool 10 has a fastening hole 42. The fastening hole 42 is configured for a connection of the cutting tool 10 to the base element 16. The fastening hole 42 is configured to accommodate a fastening member 102 for a connection of the cutting tool 10 to the base element 16. The fastening hole 42 is introduced in the base body 24 in the rear side 30 of the cutting tool 10. The fastening hole 42 extends from the rear side 30 into the base body 24. The fastening hole 42 is realized as a blind hole. The fastening hole 42 is not realized such that it continues as far as the front side 28. The fastening hole 42 comprises an internal thread 44. For a fastening the cutting tool 10, a fastening member 102, for example a fastening member 102 realized as a screw, can be screwed into the fastening hole 42 via the internal thread 44 and can thus be fixedly connected. The fastening hole 42 is preferably arranged in a lower half of the rear side 30 of the cutting tool 10. The fastening hole 42 is introduced in the fastening region 36, in particular in a first subregion 38 of the fastening region 36. In principle it would also be conceivable that the fastening hole 42 is realized as a through hole that is continuous from the rear side 30 to the front side 28. In principle it would also be conceivable that the fastening hole 42 has no internal thread. The fastening hole 42 that is realized as a through hole would be configured such that for a connection to the base element 16, a fastening member 102 is guided through the fastening hole 42, wherein a screw head or a nut would adjoin the front side 28 in order to connect the cutting tool 10 to the base element 16. The fastening hole 42 has a fastening hole longitudinal axis 46. The fastening hole longitudinal axis 46 is realized as a middle axis of the fastening hole 42. The fastening hole 42 extends along the fastening hole longitudinal axis 46.

The first subregion 38 of the fastening region 36 includes an angle B with the fastening hole longitudinal axis 46. The second subregion 40 of the fastening region 36 includes an angle C with the fastening hole longitudinal axis 46. The angle B included by the first subregion 38 of the fastening region 36 with the fastening hole longitudinal axis 46 differs from the angle C included by the second subregion 40 of the fastening region 36 with the fastening hole longitudinal axis 46. The first subregion 38 of the fastening region 36 includes an angle B with the fastening hole longitudinal axis 46 which is between 65 degrees and 75 degrees. Preferably the angle B included by the first subregion 38 of the fastening region 36 with the fastening hole longitudinal axis 46 is 70 degrees. The second subregion 40 of the fastening region 36 includes an angle C with the fastening hole longitudinal axis 46 which is between 35 degrees and 45 degrees. Preferably the angle C included by the second subregion 40 of the fastening region 36 with the fastening hole longitudinal axis 46 is 40 degrees. Slight deviations from the accurate angle specifications of the different angles are here conceivable in particular due to manufacturing tolerances.

The cutting tool 10 has a cutting-edge movement direction 104. The cutting-edge movement direction 104 is realized as a direction in which the cutting edge 22 of the cutting tool 10 moves during operation. The first subregion 38 includes an angle D with the cutting-edge movement direction 104 which is between 79 degrees and 89 degrees. Preferably the angle D included by the cutting-edge movement direction 104 with the first subregion 38 is 84 degrees. The second subregion 40 includes an angle E with the cutting-edge movement direction 104 which is between 9 degrees and 19 degrees. Preferably the angle E included by the cutting-edge movement direction 104 with the second subregion 40 is 14 degrees.

The fastening region 36 is realized at least partly as a wedge-shaped groove. The fastening region 36 is in its first subregion 38 realized at least partly as a wedge-shaped groove. The fastening region 36 comprises in its first subregion 38 at least one region in which the fastening region 36 is realized as a wedge-shaped groove. Preferably the region in which the fastening region 36 is realized as a wedge-shaped groove may extend over the entire first subregion 38. However, in principle it is also conceivable that only a portion, for example less than 50%, of the fastening region 36 is in the first subregion 38 realized as a wedge-shaped groove. Preferably it is also conceivable that the fastening region 36 is realized in the first subregion 38 as a wedge-shaped groove in several regions which are spaced apart from one another. The fastening region 36 comprises in the first subregion 38, at least in the one region in which it is realized as a wedge-shaped groove, two side walls 48, 50 which are arranged at an angle F to each other. The side walls 48, 50 of the fastening region 36 are oriented obliquely to each other. The side walls 48, 50 preferably extend over an entire longitudinal extent of the first subregion 38 of the fastening region 36. In principle several pairs of side walls 48, 50 are conceivable, which are arranged spaced apart from one another and which only region-wise realize the fastening region 36 as a wedge-shaped groove. In a remaining region the fastening region 36 could have side walls of any shape, which for example have a different angle to each other. The side walls 48, 50 include an angle F with each other which is between 130 degrees and 140 degrees. Preferably the side walls 48, 50 include an angle F of 135 degrees with each other.

The fastening region 36 comprises in its second subregion 40 at least one region in which the fastening region 36 is realized as a wedge-shaped groove. Preferably the region in which the fastening region 36 is realized as a wedge-shaped groove may extend over the entire second subregion 40. However, in principle it is also conceivable that in the second subregion 40 only a portion, for example less than 50%, of the fastening region 36 is realized as a wedge-shaped groove. Preferably it is also conceivable that in the second subregion 40 the fastening region 36 is realized as a wedge-shaped groove in several regions which are spaced apart from one another. The fastening region 36 comprises in the second subregion 40, at least in the one region in which it is realized as a wedge-shaped groove, two side walls 52, 54 which are arranged at an angle G to each other. The side walls 52, 54 of the fastening region 36 are oriented obliquely to each other. The side walls 52, 54 preferably extend over an entire longitudinal extent of the second subregion 40 of the fastening region 36. In principle several pairs of side walls 52, 54 are conceivable, which are arranged spaced apart from one another and which only region-wise realize the fastening region 36 as a wedge-shaped groove. In a remaining region the fastening region 36 could have side walls of any shape, which for example have a different angle to each other. The side walls 48, 50, 52, 54 of the wedge-shaped grooves in the two subregions 38, 40 include different angles F, G with each other. The side walls 52, 54 of the second subregion 40 include a different angle G with each other than the side walls 48, 50 of the first subregion 38. The side walls 52, 54 include an angle G with each other which is between 162 degrees and 172 degrees. Preferably the side walls 52, 54 include an angle G of 167 degrees with each other.

The base element 16 is configured for a rigid connection to the comminuting rotor 12. Preferably, the base element 16 is fixedly and rigidly welded with the base body 14 of the comminuting rotor 12 by means of a welded connection. The base element 16 is preferably realized as an elongate element. The base element 16 has an underside 56. The underside 56 faces towards the comminuting rotor 12. With its underside 56, the base element 16 is welded-on in such a way that it faces towards the base body 14 of the comminuting rotor 12. For this purpose, the underside 56 of the base element 16 preferably has a shape corresponding to an outer contour of the base body 14. The base element 16 has an upper side 58 which faces away from the comminuting rotor 12. The base element 16 has a rear side 60. The rear side 60 of the base element 16 points counter to an operative rotation direction of the comminuting rotor 12. The rear side 60 of the base element 16 is thus oriented counter to the cutting-edge movement direction 104. The base element 16 has a front side 62. The front side 62 of the base element 16 points in an operative rotation direction of the comminuting rotor 12. The base element 16 is preferably made of a metal. The base element 16 is preferably realized as a forged part.

The base element 16 comprises on its front side 62 a contact region 64. The contact region 64 is configured such that the cutting tool 10 with its fastening region 36 at least partly adjoins in a form-fitting manner. The contact region 64 is configured for a form-fitting connection of the cutting tool 10. In a mounted state, the cutting tool 10 is connected to the base element 16 and thus to the comminuting rotor 12 via the contact region 64. The contact region 64 is realized so as to correspond to the fastening region 36 of the cutting tool 10.

The base element 16 has a fastening hole 66. The fastening hole 66 has a fastening hole longitudinal axis 74. In a mounted state, the fastening hole longitudinal axis 74 of the fastening hole 66 is oriented coaxially with the fastening hole longitudinal axis 46 of the fastening hole 42 of the cutting tool 10. The fastening hole 66 is configured for a fixing of the cutting tool 10 in the contact region 64. The fastening hole 66 is configured for guiding a fastening member 102 through the fastening hole 66. The fastening hole 66 is realized as a through hole. The fastening hole 66 extends from the front side 62 as far as the rear side 60 of the base element 16. The fastening hole 66 is arranged in a region of the contact region 64. The fastening hole 66 is realized as a simple through hole, which in particular has no internal thread. The base element 16 has a support surface 68 on its rear side 60 in the region of the fastening hole 66. For a fastening of the cutting tool 10, a fastening member 102 that is realized as a screw can be supported with its screw head on the support surface 68. In principle it would also be conceivable that the fastening hole 66 of the base element 16 is realized as a blind hole having an internal thread and that the fastening hole 42 of the cutting tool 10 is realized as a through hole. For a fastening of the cutting tool 10 to the base element 16, a fastening member 102 that is realized as a screw would be guided from the front side 28 of the cutting tool 10 through the fastening hole 42 of the cutting tool 10 that is realized as a through hole and would be screwed in the fastening hole 66 of the base element 16, which in this case has an internal thread.

The contact region 64 of the base element 16 is realized so as to be substantially L-shaped. The contact region 64 comprises a first subregion 70. The first subregion 70 of the contact region 64 of the base element 16 is realized so as to correspond to the first subregion 38 of the fastening region 36 of the cutting tool 10. The contact region 64 comprises a second subregion 72. The second subregion 72 of the contact region 64 of the base element 16 is realized so as to correspond to the second subregion 40 of the fastening region 36 of the cutting tool 10. The two subregions 70, 72 are arranged at an angle to each other. The subregions 70, 72 include an angle J, which corresponds to the angle A of the subregions 38, 40 of the fastening region 36. The first subregion 70 of the contact region 64 includes an angle K with the fastening hole longitudinal axis 74 of the fastening hole 66 of the base element 16. The angle K is preferably between 65 degrees and 75 degrees, in particular 70 degrees. The angle K included by the first subregion 70 of the contact region 64 of the base element 16 with the fastening hole longitudinal axis 74 of the fastening hole 66 corresponds to the angle B included by the first subregion 38 of the fastening region 36 of the cutting tool 10 with the fastening hole longitudinal axis 46. The second subregion 72 of the contact region 64 includes an angle L with the fastening hole longitudinal axis 74 of the fastening hole 66 of the base element 16. The angle L is preferably between 35 degrees and 45 degrees, in particular 40 degrees. The angle L included by the second subregion 72 of the contact region 64 of the base element 16 with the fastening hole longitudinal axis 74 of the fastening hole 66 corresponds to the angle C included by the second subregion 40 of the fastening region 36 of the cutting tool 10 with the fastening hole longitudinal axis 46.

The contact region 64 is realized as at least one wedge-shaped elevation, which is formed correspondingly to the fastening region 36 that is realized as a wedge-shaped groove. The first subregion 70 of the contact region 64 is directed frontwards, away from the rear side 60 of the base element 16. The first subregion 70 of the contact region 64 is realized as a wedge-shaped elevation. The first subregion 70 has a first side surface 76 and a second side surface 78, which are oriented at an angle to each other. The side surfaces 76, 78 of the first subregion 70 are directed away from each other. The two side surfaces 76, 78 are in each case directed laterally outwards. The two side surfaces 76, 78 include an angle H with each other. The two side surfaces 76, 78 include an angle H with each other which is between 130 degrees and 140 degrees. The angle H included by the side surfaces 76, 78 is preferably 135.5 degrees. The angle H included by the two side surfaces 76, 78 of the first subregion 70 of the contact region 64 is realized so as to correspond to the angle F included by the side walls 48, 50 in the first subregion 38 of the fastening region 36. The wedge-shaped elevation comprises a web 80 between the two side surfaces 76, 78. The web 80 preferably has a width between 2 mm and 8 mm, preferably a width of approximately 5 mm.

The second subregion 72 of the contact region 64 is directed upwards, away from the underside 56 of the base element 16. The second subregion 72 of the contact region 64 is arranged at a lower end of the first subregion 70. Viewed counter to the cutting-edge movement direction 104, the second subregion 72 of the contact region 64 is arranged before the first subregion 70. The second subregion 72 of the contact region 64 is realized as a wedge-shaped elevation. The second subregion 72 has a first side surface 82 and a second side surface 84, which are oriented at an angle to each other. The side surfaces 82, 84 of the second subregion 72 are directed away from each other. The two side surfaces 82, 84 are in each case directed laterally outwards. The two side surfaces 82, 84 include an angle I with each other. The two side surfaces 82, 84 include an angle I with each other which is between 162 degrees and 172 degrees. The angle I included by the side surfaces 82, 84 is preferably 168 degrees. The angle I included by the two side surfaces 82, 84 of the second subregion 72 of the contact region 64 is preferably realized to be by between 0.1 degrees and 3.5 degrees greater than the angle G included by the side walls 52, 54 in the second subregion 40 of the fastening region 36. The angle I included by the two side surfaces 82, 84 of the second subregion 72 of the contact region 64 is preferably realized to be by 0.5 degrees greater than the angle G included by the side walls 52, 54 which surround the wedge-shaped groove in the second subregion 40 of the fastening region 36. As a result, during assembly the side walls 52, 54, which form the wedge-shaped groove in the second subregion 40 of the fastening region 36, are tensioned with the side surfaces 82, 84 of the second subregion 72 of the contact region 64. This allows particularly secure mounting of the cutting tool 10 on the base element 16. As a result of tightening the fastening member 102 that is realized as a screw, the second subregion 40 of the fastening region 36 is tensioned with the second subregion 72 of the contact region 64. The wedge-shaped elevation comprises a web 86 between the two side surfaces 82, 84. The web 86 preferably has a width between 2 mm and 8 mm.

The second subregion 72 of the contact region 64 preferably has an extent which is smaller than a thickness of the cutting tool 10, in particular than a thickness of the cutting tool 10 at its lower end. As a result, in a state when the cutting tool 10 is mounted at the base element 16, the cutting tool 10 projects with its underside 34 beyond the second subregion 72 of the contact region 64 of the base element 16. By way of said projecting, wear protection can be provided for the base element 16, which is not easily exchangeable, in particular in contrast to the cutting tool 10.

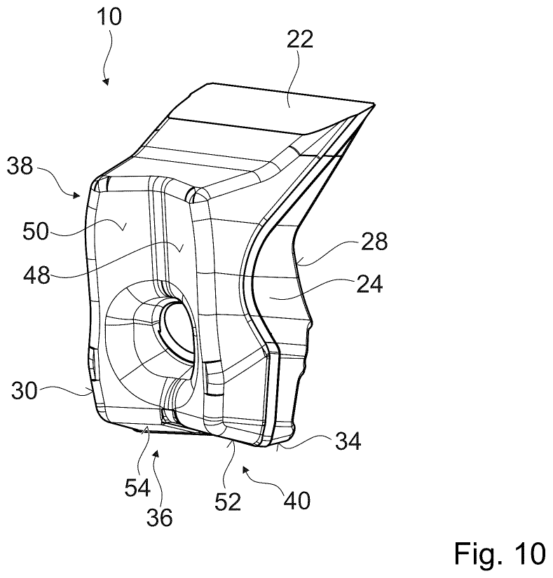

In FIG. 10 a second exemplary embodiment of a cutting tool 10 according to the invention is shown. In contrast to the first exemplary embodiment, the cutting tool 10 comprises a cutting edge 22 that is realized integrally with the base body 24 of the cutting tool 10. The cutting edge 22 is realized together with the base body 24. The cutting tool 10 forms the cutting edge 22 and the base body 24 conjointly as a forged tool. The fastening region 36 is realized in the way described above with respect to the cutting tool 10 in the first exemplary embodiment. This will therefore not be discussed in detail here. In principle it would also be conceivable that the cutting tool 10 has in a further exemplary embodiment a different implementation of the cutting edge. In principle it would also be conceivable that the cutting tool 10 has two or more than two cutting edges. The number and implementation of the cutting edges is independent of an implementation of the fastening region 36 and of the manner in which the cutting tool 10 is connected to a base element 16, 18, 20.

1. A cutting tool for a comminuting rotor, in particular for a comminution of at least one of wood and soil, with at least one cutting edge and with at least one fastening region that is preferably at least partly realized as a fastening hollow and comprises in a longitudinal extent two subregions which are oriented at an angle to each other, wherein the subregions include an angle which is greater than 90 degrees.

2. The cutting tool according to claim 1, wherein the subregions include an angle of 95 degrees to 120 degrees, preferably of 100 degrees to 115 degrees, with each other.

3. The cutting tool according to claim 1, further comprising a fastening hole longitudinal axis, wherein the first subregion includes an angle with the fastening hole longitudinal axis which differs from an angle included by the fastening hole longitudinal axis with the second subregion.

4. The cutting tool according to claim 1, further comprising a fastening hole longitudinal axis, wherein a first subregion of the fastening region includes an angle with the fastening hole longitudinal axis which is between 65 degrees and 75 degrees.

5. The cutting tool according to claim 1, further comprising a fastening hole longitudinal axis, wherein the second subregion of the fastening region includes an angle with the fastening hole longitudinal axis which is between 35 degrees and 45 degrees.

6. The cutting tool according to claim 1, wherein the first subregion is realized as a main support region having a greater extent than the second subregion.

7. The cutting tool according to claim 1, the first subregion is realized as at least one subregion of a rear side of the cutting tool.

8. The cutting tool according to claim 1, wherein the second subregion is realized as at least one subregion of an underside of the cutting tool.

9. The cutting tool according to claim 1, further comprising a cutting-edge movement direction, wherein a first subregion of the fastening region includes an angle with the cutting-edge movement direction which is between 79 degrees and 89 degrees.

10. The cutting tool according to claim 1, further comprising a cutting-edge movement direction, wherein the second subregion of the fastening region includes an angle with the cutting-edge movement direction which is between 9 degrees and 19 degrees.

11. The cutting tool according to claim 1, wherein the fastening region is realized at least partly as a wedge-shaped groove having side walls which are arranged at an angle to each other that is in a range from 130 degrees to 172 degrees.

12. The cutting tool according to claim 1, wherein the fastening region is in each of its two subregions realized at least partly as a wedge-shaped groove, with side walls of the wedge-shaped grooves having different angles to each other in the two subregions.

13. The cutting tool according to claim 1, further comprising a fastening hole which extends from a rear side into the cutting tool and is configured for fastening a fastening member.

14. A cutting system with a cutting tool according to claim 1, further comprising a base element, which is configured for a rigid connection to the comminuting rotor and which has on a front side a contact region that is configured such that the cutting tool at least partly adjoins with its fastening region in a form-fitting manner.

15. The cutting system according to claim 14, wherein the contact region comprises a first subregion, which is realized correspondingly to the first subregion of the cutting tool, and comprises a second subregion, which is realized correspondingly to the second subregion of the cutting tool.

16. The cutting system according to claim 15, wherein the contact region comprises a second subregion, which at least partially forms a wedge-shaped elevation, with side surfaces of the wedge-shaped elevations having an angle which is minimally greater, preferably by 0.1 degrees to 3.5 degrees greater, than the angle of the second subregion of the fastening region of the cutting tool.

17. The cutting system according to claim 14, wherein the second subregion of the contact region has an extent which is smaller than a thickness of the cutting tool.

18. The cutting system according to claim 14, wherein in a state when the cutting tool is mounted at the base element, the cutting tool projects with its underside beyond the second subregion of the contact region of the base element.

19. The cutting system according to claim 14, wherein the base element does not engage around the cutting tool.
